(19) United States
(12) Patent Application Publication
(10) Pub. No.: US 2014/0217643 A1
(43) Pub. Date: Aug. 7, 2014

(54) CARBON NANOTUBE FIBER AND METHOD FOR PRODUCING THE SAME

(71) Applicant: HONDA MOTOR CO., LTD., Tokyo (JP)

(72) Inventors: Hidefumi Nikawa, Wako-shi (JP); Masahiro Ohta, Wako-shi (JP); Toshio Tokune, Wako-shi (JP)

(73) Assignee: HONDA MOTOR CO., LTD., Tokyo (JP)

(21) Appl. No.: 14/170,798

(22) Filed: Feb. 3, 2014

(30) Foreign Application Priority Data
Feb. 5, 2013 (JP) 2013-020290
Jan. 30, 2014 (JP) 2014-015189

(51) Int. Cl. C01B 31/02

(52) U.S. Cl. CPC C01B 31/022; C01B 31/0226; C01B 31/0253
USPC 264/299; 423/447.2

(57) ABSTRACT

There are provided carbon nanotube fibers having excellent mechanical property and a method for producing the same. In a long carbon nanotube fiber 11 in which a plurality of carbon nanotubes 12 are assembled, the carbon nanotubes 12 comprise a diameter ranging from 0.4 to 100 nm and are oriented in an angle ranging from 0 to 5° with respect to axial direction of the carbon nanotube fiber 11.

### BACKGROUND OF THE INVENTION

1. Field of the Invention

The present invention relates to carbon nanotube fibers and a method for producing the same.

2. Description of the Related Art

The use of carbon nanotube fibers in which a plurality of carbon nanotubes are assembled in a long shape for electronic devices, conductive wires, batteries, fiber-reinforced plastics, and the like has been studied. The carbon nanotube fibers are required to have excellent mechanical property, such as a tensile strength and a rigidity, for use in the applications as described above.

A twisted carbon nanotube fiber 32 composed of a plurality of carbon nanotubes 31, for example, as shown in FIG. 2 has conventionally been known as a carbon nanotube fiber. The twisted carbon nanotube fiber 32 is formed by twisting a plurality of carbon nanotubes 31 in a spinning apparatus 33, wherein the plurality of the carbon nanotubes 31 are paralleled by a drawing unit 37 from a carbon nanotube forest 35, in which the plurality of the carbon nanotubes 31 are grown on a substrate 34, and wound up on the drawing unit 37 while being twisted by a twisting unit 36 (see National Publication of International Patent Application No. 2008-523254).

However, there is an inconvenience that the conventional twisted carbon nanotube fibers do not have sufficient mechanical property.

An object of the present invention is to provide carbon nanotube fibers having excellent mechanical property and a method for producing the same by solving such an inconvenience.

### SUMMARY OF THE INVENTION

As a result of extensive and intensive studies, the present inventors have found that, in the conventional twisted carbon nanotube fibers, mechanical property is improved when the orientation angle of the carbon nanotubes with respect to the axial direction decreases.

Thus, the present invention has been made based on the above finding, and in order to achieve the above object, the present invention provides a long carbon nanotube fiber in which a plurality of carbon nanotubes are assembled, wherein the carbon nanotubes comprise a diameter ranging from 0.4 to 100 nm and are oriented in an angle ranging from 0 to 5° with respect to the axial direction of the carbon nanotube fiber.

In the carbon nanotube fibers of the present invention, it is technically difficult to decrease the diameter of the carbon nanotubes to less than 0.4 nm On the other hand, if the carbon nanotubes comprise a diameter exceeding 100 nm, the chemical or physical characteristics that are specific to the carbon nanotubes, such as a reactivity, an absorptive property, a conductive property, a mechanical property and the like, cannot be obtained.

In the carbon nanotube fibers of the present invention, the plurality of the carbon nanotubes are oriented and assembled in an angle ranging from 0 to 5° with respect to the axial direction of the carbon nanotube fibers in a state where they are not substantially twisted. Since the carbon nanotubes are not substantially twisted in the carbon nanotube fibers of the present invention, the carbon nanotube fibers can have improved mechanical property, such as the tensile strength and the rigidity, as compared with the conventional twisted carbon nanotube fibers.

In the carbon nanotube fibers of the present invention, if the carbon nanotubes are oriented in an angle exceeding 5° with respect to the axial direction of the carbon nanotube fibers, sufficient mechanical property cannot be obtained.

The reason why the carbon nanotube fibers which are not substantially twisted have improved strength as compared with the conventional twisted carbon nanotube fibers, is conceived as follows.

Generally, in yarn consisting of monofilaments having a diameter of equal to or larger than submicron, by twisting the monofilaments, the monofilaments at a periphery of the yarn compress the monofilaments inside the yarn, and the fiber density becomes higher. By doing so, the monofilaments contact each other while strongly pressing against each other, and a frictional force acting between the adjacent monofilaments becomes larger. On the other hand, in a yarn in which the monofilaments are not substantially twisted, the frictional force is hardly obtained.

Therefore, in the yarn consisting of the monofilaments having the diameter of equal to or larger than submicron, superior mechanical property may be obtained in the twisted yarn, compared to the yarn in which the monofilaments are not substantially twisted. However, in the twisted yarn, when a twisting angle exceeds an optimum range, a deviation of a vector between a friction force between the monofilaments applied by twisting, and an external force acting on the twisted yarn, becomes larger, and the mechanical property decreases.

On the other hand, in a yarn consisting of the monofilaments having the diameter of nanometer order, the effect of intermolecular forces acting between the adjacent fibers cannot be ignored, and the monofilaments are in the state of being attracted together by the intermolecular forces. Further, when the intermolecular forces becomes maximum, thermo dynamics become local minimum, so that when the monofilaments once contact each other, the monofilaments maintain the contacted state. By doing so, in the yarn consisting of the monofilaments having the diameter of the nanometer order, the contact force between the monofilaments is expressed, regardless of the twisting angle.

Therefore, in the yarn consisting of the monofilaments having the diameter of the nanometer order, the mechanical property become the largest, when the deviation of the vector between the frictional force and the external force becomes the minimum at the twisting angle in the vicinity of 0°, that is, in a non-twisted yarn in which the monofilaments are not substantially twisted, t.

From the reasons explained above, it is conceived that the carbon nanotube fiber of the present invention has superior mechanical property compared to the conventional carbon nanotube fibers corresponding to the twisted yarn.

Further, in the carbon nanotube fibers of the present invention, it is preferable that the carbon nanotubes have a length ranging from 10 to 5000 μm. In a case where the length of the carbon nanotube fibers are less than 10 μm, there may be cases where the carbon nanotube fibers cannot be formed, even if the carbon nanotubes are gathered. On the other hand, the carbon nanotubes of the length exceeding 5000 μm is difficult to obtain.

Further, in the carbon nanotube fibers of the present invention, the cross-sectional filling rate as a proportion of the carbon nanotubes with respect to the cross-sectional area of the carbon nanotube fibers preferably ranges from 50 to 95%. Since the carbon nanotube fibers of the present invention are in a state where a large number of the carbon nanotubes are compressed in the diameter direction and gathered with high density without forming a gap, the carbon nanotube fibers can have further improved mechanical property and improved electrical conductivity as well.

In the carbon nanotube fibers of the present invention, if the cross-sectional filling rate is less than 50%, it is impossible to obtain excellent electrical conductivity and excellent mechanical property in combination. On the other hand, it is technically difficult to increase the cross-sectional filling rate to a level exceeding 95%.

Incidentally, since the conventional carbon nanotube fibers are twisted, cross-sectional shape cannot but be generally circular. However, since the carbon nanotube fibers of the present invention are in a state where they are not substantially twisted, the carbon nanotube fibers can comprise not only a generally circular shape in the cross-sectional view but also a desired cross-sectional shape corresponding to a shape in applications, and can comprise a desired contact area and surface area corresponding to applications.

As the desired cross-sectional shape, for example, a shape may be selected from the group consisting of a circle, an ellipse, a convex polygon, and a concave polygon. Specifically, in the carbon nanotube fiber in which the cross-sectional shape is a hexagon or a cruciform, when the plurality of the carbon nanotube fibers are further bundled to form a carbon nanotube fiber assembly, it becomes possible to gather the carbon nanotube fibers without any space therebetween, so that the carbon nanotube fiber assembly superior in mechanical property may be obtained.

Further, the carbon nanotube fiber of the present invention may comprise a pore portion in the central part of the fiber, and a thread member may be inserted into the central part of the fiber.

As the thread member, for example, a wire consisting of at least one type of material selected from the group consisting of a metal, a metal oxide, a glass fiber, a carbide, a carbon fiber, and a resin, may be used, and preferably, a copper or a TiNi may be used. Specifically, according to the carbon nanotube fiber in which a copper wire is inserted as the thread member, superior electrical conductivity than the carbon nanotube fiber alone may be obtained.

Furthermore, the carbon nanotube fiber of the present invention can be advantageously produced by a method for producing a carbon nanotube fiber comprising the steps of: paralleling a plurality of carbon nanotubes comprising a diameter ranging from 0.4 to 100 nm from a carbon nanotube forest in which the plurality of the carbon nanotubes are grown on a substrate, and forming a carbon nanotube assembly in a bundled shape; and inserting the carbon nanotube assembly into a pore having a diameter smaller than the diameter of the carbon nanotube assembly and forming the carbon nanotube fiber by orienting and assembling the plurality of the carbon nanotubes in an angle ranging from 0 to 5° with respect to the axial direction.

According to the production method of the present invention, the bundled carbon nanotube assembly is formed by paralleling the plurality of the carbon nanotubes in a state where they are not twisted from the carbon nanotube forest, and then the carbon nanotube assembly is inserted into a pore having a diameter smaller than the diameter of the carbon nanotube assembly. In this way, it is possible to form a carbon nanotube fiber in which a plurality of carbon nanotubes are oriented and assembled in an angle ranging from 0 to 5° with respect to the axial direction.

In the production method of the present invention, it is preferable that the carbon nanotube fiber is aligned to a length ranging from 10 to 5000 μm.

In the production method of the present invention, as the substrate, for example, a Si substrate on which an Al film and an Fe film are deposited, may be used.

Further, in the production method of the present invention, it is preferable that the carbon nanotube forest has a density of 5 to 388 mg/cm³, and by doing so, the carbon nanotube fiber with the cross-sectional filling rate ranging from 50 to 95% may be obtained. When the density of the carbon nanotube forest is less than 5 mg/cm³, the carbon nanotube fiber having the cross-sectional filling rate in the above-mentioned range may not be obtained in some cases, and the carbon nanotube forest having the density exceeding 388 mg/cm³ is difficult to obtain.

The production method of the present invention preferably further comprises the step of removing impurities from the carbon nanotube assembly, between the step of forming the carbon nanotube assembly and the step of inserting the carbon nanotube assembly into the pore. By removing the impurities, it is possible to prevent the pore from clogging with the impurities when the carbon nanotube assembly is inserted into the pore, and to obtain high-quality carbon nanotube fibers free from defects.

The step of removing impurities may be performed, for example, by blowing the impurities with a blower.

Further, in the production method of the present invention, the carbon nanotube assembly is preferably inserted into a plurality of pores in which the diameter of the pores decreases in steps from the upstream side toward the downstream side in the spinning direction. By compressing the carbon nanotube assembly in steps in the diameter direction, it is possible to prevent the carbon nanotubes from being cut from a stress generated by a friction between a pore wall surface and the carbon nanotube assembly from abrupt shape change, and to easily obtain carbon nanotube fibers having a cross-sectional filling rate in the range as described above.

Further, in the production method of the present invention, the cross section of a pore arranged on the most downstream side in the spinning direction preferably comprises a shape corresponding to a desired cross-sectional shape of the carbon nanotube fiber. In this way, a carbon nanotube fiber comprising a desired cross-sectional shape can be obtained.

As the desired cross-sectional shape, for example, a shape selected from the group consisting of a circle, an ellipse, a convex polygon, and a concave polygon may be used, and specifically, a shape consisting of a hexagon and a cruciform is preferred.

Further, in the production method of the present invention, the pore preferably comprises a core arranged in the central part thereof. By removing the core, a carbon nanotube fiber comprising a pore in the central part thereof can be obtained.

As the core, for example, a thread member may be used. Further, as the thread member, a wire consisting of at least one type of material selected from the group consisting of a metal, a metal oxide, a glass fiber, a carbide, a carbon fiber, and a resin, may be used, and preferably a copper or a TiNi may be used. Specifically, by using a TiNi shape memory alloy wire as the thread member, it is possible to easily restore the shape of the wire, in a case where the wire as the core deformed during formation of the carbon nanotube fiber.

Further, by filling the pore of the resulting carbon nanotube fiber with a material such as a metal, a metal oxide, a glass fiber, a carbide, a carbon fiber, or a resin, a carbon nanotube fiber comprising a function resulting from the above material can be obtained, the function being not obtained solely from the original carbon nanotube fiber.

Further, in the present invention, the production method may further comprise the step of: winding up the carbon nanotube fiber in which a thread member is arranged in the central part thereof by a drawing unit, wherein the drawing unit is configured to draw the plurality of the carbon nanotubes from the carbon nanotube forest and wind up the carbon nanotube fiber in which the plurality of the carbon nanotubes are assembled and the thread member of a long-length is arranged in the central part of the pore along the longitudinal direction thereof.

As the thread member, for example, a material such as a metal, a metal oxide, a glass fiber, a carbide, a carbon fiber, or a resin can be used, and preferably a copper or a TiNi may be used.

In this way, a carbon nanotube fiber comprising a function resulting from the material constituting the thread member can be obtained, the function being not obtained solely from the original carbon nanotube fiber.

### BRIEF DESCRIPTION OF THE DRAWINGS

FIG. 1 is a schematic view showing a spinning apparatus for producing the carbon nanotube fibers of the present embodiment;

FIG. 2 is a schematic view of a spinning apparatus for producing conventional twisted carbon nanotube fibers;

FIG. 3A is a schematic view showing a first modification of the spinning apparatus of the present embodiment;

FIG. 3B is a schematic view showing a second modification of the spinning apparatus of the present embodiment;

FIG. 4 is a graph showing the relationship between the twisting angle and the mechanical property of carbon nanotube fibers;

FIG. 5A is an enlarged front picture of the carbon nanotube fiber of Example 1;

FIG. 5B is an enlarged cross-sectional picture of the carbon nanotube fiber of Example 1;

FIG. 5C is an enlarged cross-sectional picture of the carbon nanotube fiber of Example 1;

FIG. 6 is a graph showing the relationship between the cross-sectional filling rate and the electrical conductivity of carbon nanotube fibers;

FIG. 7 is a graph showing the relationship between the cross-sectional filling rate and the tensile strength of carbon nanotube fibers;

FIG. 8 is a graph showing the relationship between the cross-sectional filling rate and the rigidity of carbon nanotube fibers;

FIG. 9A is an enlarged front picture of the carbon nanotube fiber of Example 2;

FIG. 9B is an enlarged cross-sectional picture of the carbon nanotube fiber of Example 2;

FIG. 9C is an enlarged cross-sectional picture of the carbon nanotube fiber of Example 2;

FIG. 10A is an enlarged picture of a die used for the formation of the carbon nanotube fiber of Example 10;

FIG. 10B is an enlarged cross-sectional picture of the carbon nanotube fiber of Example 10;

FIG. 11A is an enlarged picture of a die used for the formation of the carbon nanotube fiber of Example 11;

FIG. 11B is an enlarged cross-sectional picture of the carbon nanotube fiber of Example 11;

FIG. 12A is an enlarged cross-sectional picture of the carbon nanotube fiber of Example 12; and

FIG. 12B is an enlarged cross-sectional picture of the carbon nanotube fiber of Example 13.

### DETAILED DESCRIPTION OF THE PREFERRED EMBODIMENTS

Next, the embodiments of the present invention will be described in more detail with reference to the attached drawings.

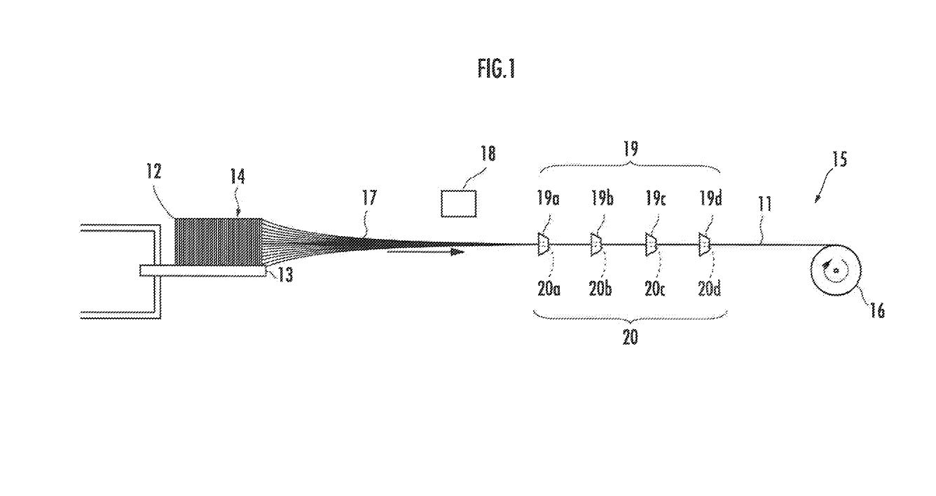

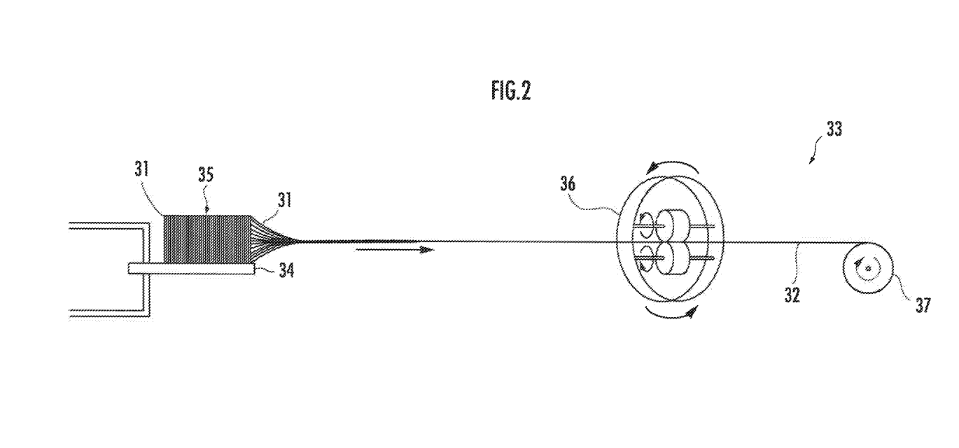

The carbon nanotube fiber 11 of the present embodiment as shown in FIG. 1 is a long body in which a plurality of carbon nanotubes 12 are assembled, and it is produced as follows.

First, a plurality of carbon nanotubes 12 are grown oriented in the vertical direction on a substrate 13 by a conventionally known CVD method such as a heat CVD (Chemical Vapor Deposition) method, a super growth method, an alcohol CVD method, or a plasma CVD method to form a carbon nanotube forest 14. For example, a silicon substrate 13, on which an Al film having a thickness of 1 to 50 nm is deposited and an Fe film having a thickness of 0.1 to 2.5 nm is deposited on the Al film, is arranged in a CVD apparatus, and the substrate is heated at a temperature of 700 to 900° C. for 5 minutes to 1 hour in a mixed gas atmosphere containing helium, hydrogen, and acetylene in a mixing ratio of 0.01-10 SLM:0.01-10 SLM:0.001-1 SLM. Thereby, the acetylene can be thermally decomposed to allow a plurality of carbon nanotubes 12 comprising a diameter ranging from 0.4 to 100 nm and a length of 10 to 5000 μm to grow to form the carbon nanotube forest 14 on the substrate 13. The carbon nanotube forest 14 comprises a density of 5 to 388 mg/cm³.

Next, in a spinning apparatus 15, the plurality of the carbon nanotubes 12 are paralleled in a state where they are not twisted from the carbon nanotube forest 14 by a drawing unit 16. Thereby, the plurality of the carbon nanotubes 12 are gradually assembled as one bundle along the spinning direction to form a carbon nanotube assembly 17.

Next, impurities adhering to the resulting carbon nanotube assembly 17 are removed by an impurity removing unit 18. For example, a blower that blows away the impurities by wind can be used as the impurity removing unit 18.

Next, the carbon nanotube assembly 17 is inserted into each pore 20 of a plurality of dies 19 and then wound up on the drawing unit 16. Each pore 20a, 20b, 20c, or 20d provided in each die 19a, 19b, 19c, or 19d, respectively, is, for example, circular, and the pore diameter decreases in steps from the upstream side toward the downstream side in the spinning direction. The carbon nanotube assembly 17 is successively inserted into the plurality of pores 20a, 20b, 20c, and 20d in order to thereby be compressed in the diameter direction in steps and then wound up on the drawing unit 16.

In the carbon nanotube fibers 11 obtained in the manner as described above, the carbon nanotubes 12 are oriented in an angle ranging from 0 to 5° with respect to the axial direction in a state where they are not substantially twisted. Further, in the carbon nanotube fibers 11, the cross-sectional filling rate as a proportion of the carbon nanotubes 12 with respect to the cross-sectional area of the carbon nanotube fibers 11 ranges from 50 to 95%.

Since the carbon nanotubes 12 are not substantially twisted in the carbon nanotube fibers 11 of the present embodiment, the carbon nanotube fibers 11 can have improved mechanical property, such as the tensile strength and the rigidity, as compared with the conventional twisted carbon nanotube fibers 32.

Further, the carbon nanotube fibers 11 of the present embodiment each have a cross-sectional filling rate ranging from 50 to 95% as a result of having compressed the carbon nanotube assembly 17 in the diameter direction. The cross-sectional filling rate corresponds to 10 to 10⁷ nanotubes/μm² when the factor is represented by the number of carbon nanotubes 12 per the cross-sectional area of a carbon nanotube fiber 11, which is in a state where a large number of carbon nanotubes 12 are gathered with high density without forming a gap. For this reason, the carbon nanotube fibers 11 of the present embodiment can have further improved mechanical property, and can have an improved electrical conductivity as well.

In the production method of the present embodiment, impurities adhering to the carbon nanotube assembly 17 are removed by the impurity removing unit 18, such as a blower. Therefore, it is possible to prevent the pore 20 from clogging with the impurities when the carbon nanotube assembly 17 is inserted into the pore 20 and obtain high-quality carbon nanotube fibers 11 free from defects.

Further, in the production method of the present embodiment, the cross section of the pore 20d arranged on the most downstream side in the spinning direction comprises a circular shape, but it may comprise a non-circular shape corresponding to a desired cross-sectional shape of the carbon nanotube fiber 11, such as convex polygons such as ellipse and hexagon and concave polygons such as cross and star. In this case, the carbon nanotube fiber 11 can comprise a desired cross-sectional shape corresponding to a shape in the applications thereof, and can also comprise a desired contact area and surface area corresponding to applications such as electronic devices, conductive wires, batteries, and fiber-reinforced plastics.

Further, in the case where the carbon nanotube fiber 11 comprises a cross-sectional shape of a triangle, a quadrangle, a hexagon, a cruciform, and the like, when a plurality of carbon nanotube fibers 11 are further bundled to form a carbon nanotube fiber assembly, the carbon nanotube fibers 11 can be adhered together and gathered with no space therebetween, and a carbon nanotube fiber assembly having higher mechanical property can be obtained.

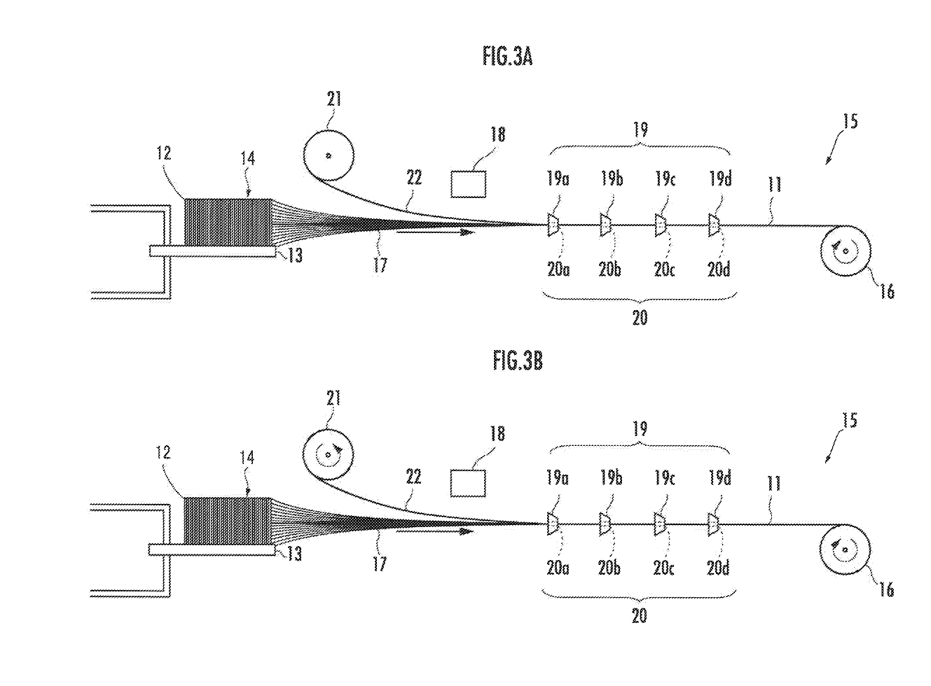

Further, as is shown in FIG. 3, each die 19 may comprise each pore 20 comprising a core arranged in the central part thereof. As the core, for example, a thread member 22 having a predetermined length, and being supported by a rotating roller 21 at one end and continuously inserted into the central part of each pore 20 of each die 19 at the other end, as shown in FIG. 3A, can be used. As the thread member 22, for example, a copper wire, a TiNi shape memory alloy wire or the like may be used.

For example, when the drawing unit 16 is operated without rotating the roller 21, as the carbon nanotubes 12 pass through the pore 20 of the die 19, the carbon nanotubes 12 entangle the thread member 22, and then only the carbon nanotubes 12 are wound up on the drawing unit 16 leaving the thread member 22. As a result, a carbon nanotube fiber 11 comprising a pore in the central part thereof can be obtained.

Moreover, the pore of the resulting carbon nanotube fiber 11 can be filled with a material such as a metal, a metal oxide, a glass fiber, a carbide, a carbon fiber, and a resin. In this case, a carbon nanotube fiber 11 containing the material inside the carbon nanotubes 12 can be obtained, so that a function resulting from the above material, the function not obtained solely from the original carbon nanotube fiber 11, may be expressed.

For example, when the drawing unit 16 is operated while rotating the roller 21, the carbon nanotubes 12 entangle the thread member 22 while passing through the pore 20 of each die 19, and the carbon nanotubes 12 may be wound up on the drawing unit 16 together with the thread member 22, as shown in FIG. 3B. By doing so, a carbon nanotube fiber 11 containing the thread member 22 inside the carbon nanotube 12 can be obtained. As the thread member 22, a material such as a metal, a metal oxide, a glass fiber, a carbide, a carbon fiber, and a resin can be used.

In the production method of the present embodiment, the number of the dies 19 each comprising the pore 20 through which the carbon nanotube assembly 17 passes is four, but the number of dies 19 is not limited to four. When the carbon nanotube assembly 17 is passed through the pore 20 to be compressed in the diameter direction in steps, the number of the dies 19 is particularly preferably two or more in order to prevent the carbon nanotubes 12 from being cut.

Next, the orientation angle of the carbon nanotubes 12 with respect to the axial direction of the carbon nanotube fiber 11 will be described.

First, similarly to the carbon nanotube forest 14, a carbon nanotube forest 35 is formed. The carbon nanotube forest 35 had carbon nanotubes 31 of a diameter of 0.7 to 30 nm and a length of 100 to 1800nm at a density of 59.4 g/cm³.

Next, using a conventional spinning apparatus 33, a plurality of carbon nanotubes 31 paralleled by a drawing unit 37 while being twisted by a twisting unit 36 are spun, so as to manufacture the carbon nanotube fiber 32.

At this time, carbon nanotube fibers 32 each having an orientation angle of carbon nanotubes 31 with respect to the axial direction of 0°, 5°, 10°, 16°, 19.5°, or 25.5° have been produced by adjusting the degree of twisting in the twisting unit 36. At this time, the angle has been adjusted so that the diameter and the cross-sectional filling rate in each carbon nanotube fiber 32 will be of the same degree (the diameter of 56±0.5 μm, and the cross-sectional filling rate of 62.5±5%).

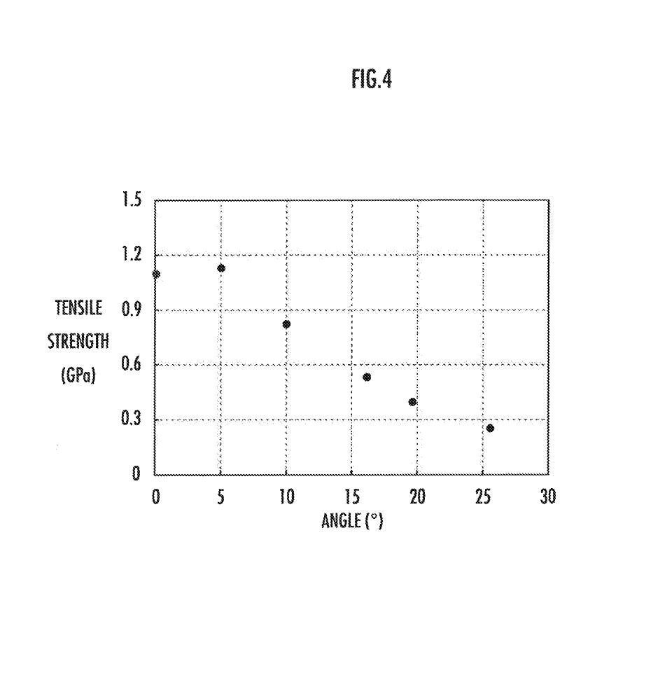

Next, a test piece having a length of 1 cm has been prepared from each of the resulting carbon nanotube fibers 32 and measured for the tensile strength using a tensile strength test machine. The obtained results are shown in FIG. 4.

FIG. 4 reveals that when carbon nanotubes 31 in a carbon nanotube fiber 32 have an orientation angle with respect to the axial direction of the carbon nanotube fiber 32 ranging from 0 to 5° and are not substantially twisted, the carbon nanotube fiber 32 has a higher tensile strength as compared with the case where the carbon nanotubes 31 have an orientation angle ranging from 10 to 30° and are twisted.

Therefore, it is obvious that the carbon nanotube fibers 11 of the present embodiment which are not substantially twisted have improved mechanical property as compared with the conventional twisted carbon nanotube fibers 32.

Next, Examples of the present embodiment will be described.

### EXAMPLE 1

In this Example, a plurality of carbon nanotubes 12 were first grown by a CVD method on a silicon substrate 13 (5 cm in length, 5 cm in width, and 500 μm in thickness) on which an Al film (5 μm in thickness) and a Fe film (2 μm in thickness) had been deposited to form a carbon nanotube forest 14. In the resulting carbon nanotube forest 14, the carbon nanotubes 12 had an average diameter of 10.6 nm, an average length of 394 μm, and a density of 84 mg/cm³.

Next, in a spinning apparatus 15 shown in FIG. 1, a plurality of carbon nanotubes 12 were paralleled in a state where they are not twisted from the carbon nanotube forest 14 by a drawing unit 16 to thereby form a carbon nanotube assembly 17 in which the plurality of the carbon nanotubes 12 are assembled.

Next, after impurities in the resulting carbon nanotube assembly 17 were removed by a blower as an impurity removing unit 18, the carbon nanotube assembly 17 was successively inserted into the pores 20a, 20b, 20c, and 20d of a plurality of dies 19a 19b, 19c, and 19d, respectively, and then wound up on the drawing unit 16. The pores 20a, 20b, 20c, and 20d each have a generally circular shape in which the pore diameter decreases in steps from the upstream side toward the downstream side in the spinning direction. The diameter of the pore 20a is 102±2.5 μm; the diameter of the pore 20b is 76±2.5 μm; the diameter of the pore 20c is 51±2.5 μm; and the diameter of the pore 20d is 38±2.5 μm.

According to the above procedures, a carbon nanotube fiber 11 in which a plurality of carbon nanotubes 12 are oriented in an angle of 0° with respect to the axial direction and assembled was formed.

Next, the cross section of the resulting carbon nanotube fiber 11 was observed by SEM to thereby measure the cross-sectional filling rate, and it was found to be 64.8%.

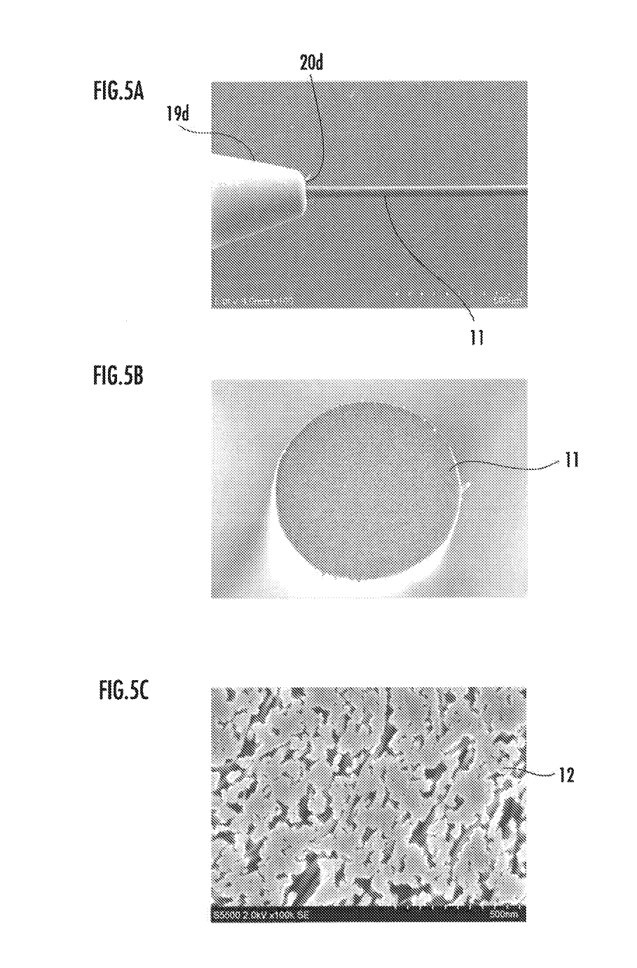

FIG. 5A shows an enlarged front picture of the carbon nanotube fiber 11, and FIG. 5B and FIG. 5C each show an enlarged cross-sectional picture of the carbon nanotube fiber 11. FIG. 5B reveals that the resulting carbon nanotube fiber 11 comprises a generally circular cross-sectional shape corresponding to the generally circular cross-sectional shape of the pore 20d of the die 19d arranged on the most downstream side in the spinning direction.

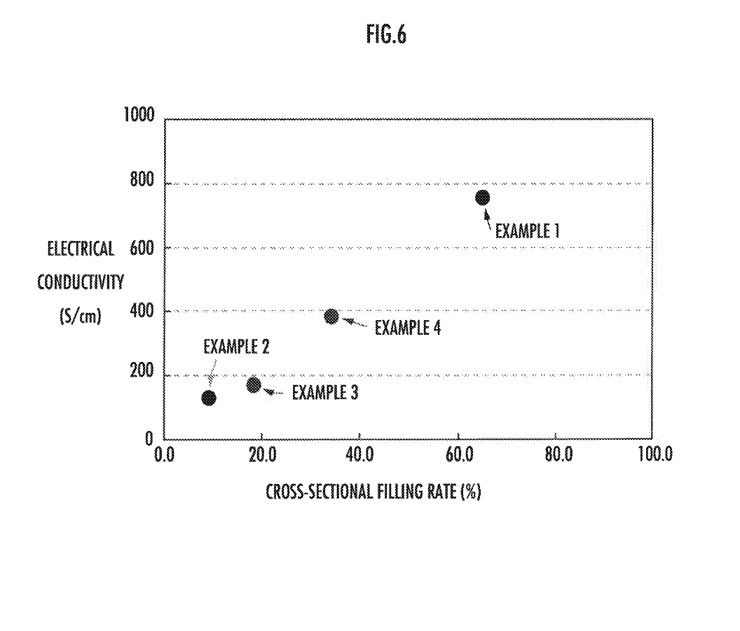

Further, the resulting carbon nanotube fiber 11 was measured for electrical conductivity by a four-terminal measurement method, and it was found to be 756 S/cm. The results are shown in FIG. 6.

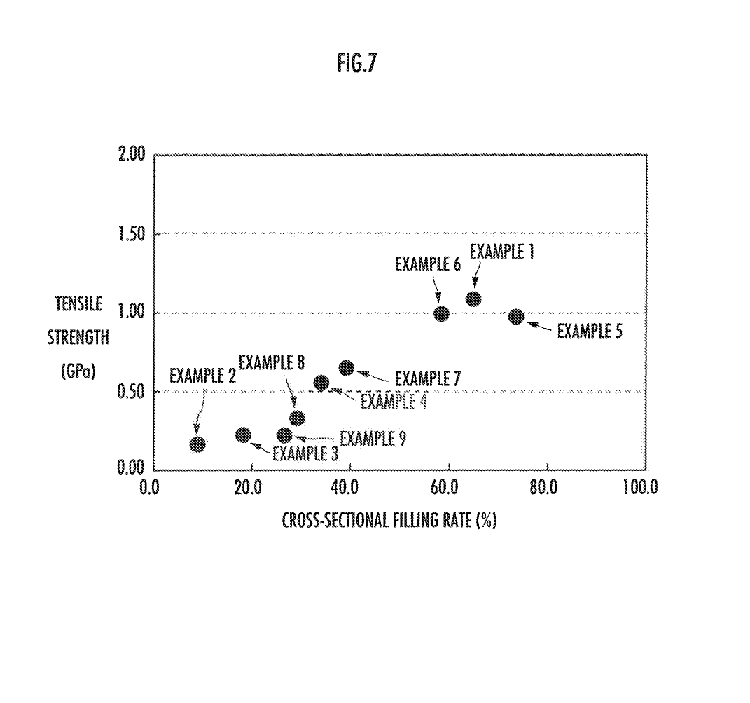

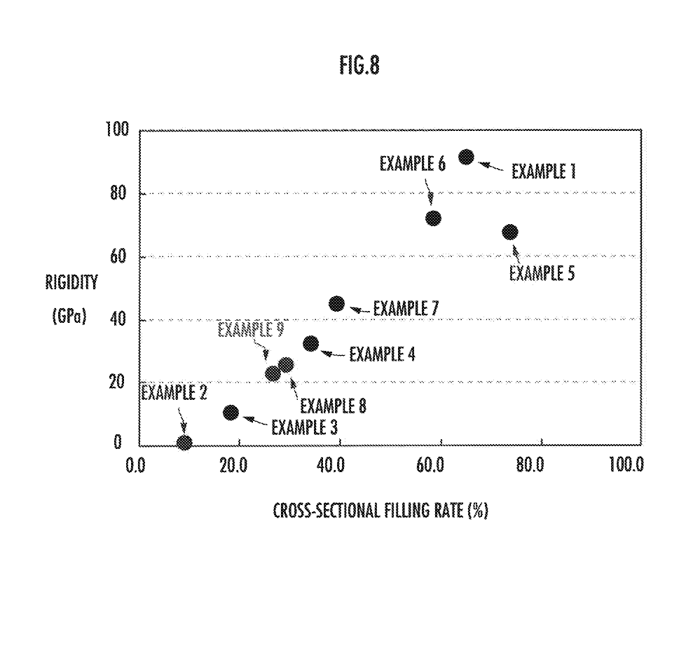

Further, a test piece having a length of 1 cm was prepared from the resulting carbon nanotube fiber 11, and the test piece was measured for tensile strength and rigidity using a tensile strength test machine. The tensile strength was found to be 1.09 GPa, and the rigidity was found to be 91.7 GPa. The results are shown in Table 1 and FIGS. 7 and 8.

### EXAMPLE 2

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was inserted only into the pore 20a of the die 19a.

Next, the cross section of the resulting carbon nanotube fiber 11 was observed by SEM to thereby determine the cross-sectional filling rate, and it was found to be 9.0%.

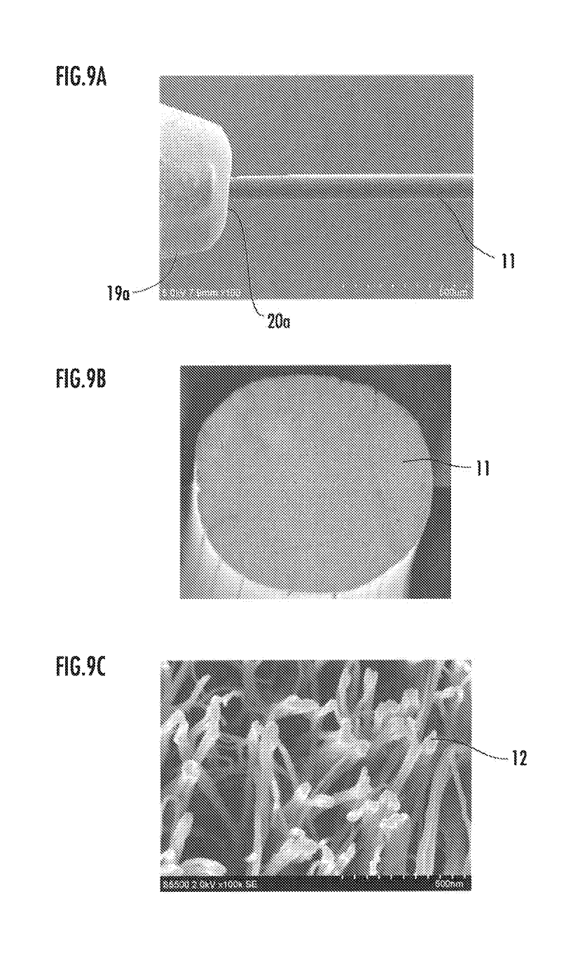

FIG. 9A shows an enlarged front picture of the carbon nanotube fiber 11, and FIG. 9B and FIG. 9C each show an enlarged cross-sectional picture of the carbon nanotube fiber 11. FIG. 5C and FIG. 9C reveal that the carbon nanotube fiber 11 of Example 1 is in a state where a plurality of carbon nanotubes 12 are gathered with higher density and has a higher cross-sectional filling rate as compared with the carbon nanotube fiber 11 of this Example.

Next, the resulting carbon nanotube fiber 11 was measured for a cross-sectional filling rate, electrical conductivity, tensile strength, and rigidity in exactly the same manner as in Example 1, and the cross-sectional filling rate, electrical conductivity, tensile strength, and rigidity were found to be 9.0%, 129 S/cm, 0.17 GPa, and 1.26 GPa, respectively. The results are shown in Table 1 and FIGS. 6, 7, and 8.

### EXAMPLE 3

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was inserted into the pore 20a of the die 19a and the pore 20b of the die 19b.

Next, the resulting carbon nanotube fiber 11 was measured for a cross-sectional filling rate, electrical conductivity, tensile strength, and rigidity in exactly the same manner as in Example 1, and the cross-sectional filling rate, electrical conductivity, tensile strength, and rigidity were found to be 18.2%, 170 S/cm, 0.23 GPa, and 10.8 GPa, respectively. The results are shown in Table 1 and FIGS. 6, 7, and 8.

### EXAMPLE 4

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was inserted into the pore 20a of the die 19a, the pore 20b of the die 19b, and the pore 20c of the die 19c.

Next, the resulting carbon nanotube fiber 11 was measured for a cross-sectional filling rate, electrical conductivity, tensile strength, and rigidity in exactly the same manner as in Example 1, and the cross-sectional filling rate, electrical conductivity, tensile strength, and rigidity were found to be 34.0%, 384 S/cm, 0.56 GPa, and 32.6 GPa, respectively. The results are shown in Table 1 and FIGS. 6, 7, and 8.

### EXAMPLE 5

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was used, and a die 19d in which the diameter of the pore 20d is 33±2.5 μm was used instead of a die 19d in which the diameter of the pore 20d is 38±2.5 μm.

Next, the resulting carbon nanotube fiber 11 was measured for a cross-sectional filling rate, tensile strength, and rigidity in exactly the same manner as in Example 1, and the cross-sectional filling rate, tensile strength, and rigidity were found to be 73.5%, 0.98 GPa, and 67.9 GPa, respectively. The results are shown in Table 1 and FIGS. 7 and 8.

### EXAMPLE 6

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was used, and a die 19d in which the diameter of the pore 20d is 43±2.5 μm was used instead of a die 19d in which the diameter of the pore 20d is 38±2.5 μm.

Next, the resulting carbon nanotube fiber 11 was measured for a cross-sectional filling rate, tensile strength, and rigidity in exactly the same manner as in Example 1, and the cross-sectional filling rate, tensile strength, and rigidity were found to be 58.3%, 1.00 GPa, and 72.3 GPa, respectively. The results are shown in Table 1 and FIGS. 7 and 8.

### EXAMPLE 7

In this Example, a carbon nanotube assembly 17 was first formed in exactly the same manner as in Example 1.

Next, a carbon nanotube fiber 11 was formed in exactly the same manner as in Example 4 except that the resulting carbon nanotube assembly 17 was used, and a die 19c in which the diameter of the pore 20c is 46±2.5 μm was used instead of a die 19c in which the diameter of the pore 20c is 51±2.5 μm.

Next, the resulting carbon nanotube fiber 11 was measured for a cross-sectional filling rate, tensile strength, and rigidity in exactly the same manner as in Example 1, and the cross-sectional filling rate, tensile strength, and rigidity were found to be 39.1%, 0.65 GPa, and 45.2 GPa, respectively. The results are shown in Table 1 and FIGS. 7 and 8. Example 8

In this Example, a carbon nanotube assembly 17 was first formed in exactly the same manner as in Example 1.

Next, a carbon nanotube fiber 11 was formed in exactly the same manner as in Example 7 except that the resulting carbon nanotube assembly 17 was used, and a die 19c in which the diameter of the pore 20c is 56±2.5 μm was used instead of a die 19c in which the diameter of the pore 20c is 46±2.5 μm.

Next, the resulting carbon nanotube fiber 11 was measured for a cross-sectional filling rate, tensile strength, and rigidity in exactly the same manner as in Example 1, and the cross-sectional filling rate, tensile strength, and rigidity were found to be 29.1%, 0.34 GPa, and 25.9 GPa, respectively. The results are shown in Table 1 and FIGS. 7 and 8.

### EXAMPLE 9

In this Example, a carbon nanotube assembly 17 was first formed in exactly the same manner as in Example 1.

Next, a carbon nanotube fiber 11 was formed in exactly the same manner as in Example 7 except that the resulting carbon nanotube assembly 17 was used, and a die 19c in which the diameter of the pore 20c is 64±2.5 μm was used instead of a die 19c in which the diameter of the pore 20c is 46±2.5 μm.

Next, the resulting carbon nanotube fiber 11 was measured for a cross-sectional filling rate, tensile strength, and rigidity in exactly the same manner as in Example 1, and the cross-sectional filling rate, tensile strength, and rigidity were found to be 26.5%, 0.23 GPa, and 23.1 GPa, respectively. The results are shown in Table 1 and FIGS. 7 and 8.

TABLE 1

| | Diameter | | | | |
|---|---|---|---|---|---|
| | of pore 20 | | | | |
| | on the most | Cross- | | | |
| | downstream | sectional | Electrical | Tensile | |
| | side | filling rate | conductivity | strength | Rigidity |
| | (μm) | (%) | (S/cm) | (GPa) | (GPa) |
| Example 1 | 38 ± 2.5 | 64.8 | 756 | 1.09 | 91.7 |
| Example 2 | 102 ± 2.5 | 9.0 | 129 | 0.17 | 1.26 |
| Example 3 | 76 ± 2.5 | 18.2 | 170 | 0.23 | 10.8 |
| Example 4 | 51 ± 2.5 | 34.0 | 384 | 0.56 | 32.6 |
| Example 5 | 33 ± 2.5 | 73.5 | | 0.98 | 67.9 |
| Example 6 | 43 ± 2.5 | 58.3 | | 1.00 | 72.3 |
| Example 7 | 46 ± 2.5 | 39.1 | | 0.65 | 45.2 |
| Example 8 | 56 ± 2.5 | 29.1 | | 0.34 | 25.9 |
| Example 9 | 64 ± 2.5 | 26.5 | | 0.23 | 23.1 |

Table 1 and FIGS. 6, 7, and 8 reveal that a carbon nanotube fiber 11 having a higher cross-sectional filling rate is obtained with the decrease of the diameter of the pore 20 of the die 19 on the most downstream side into which the carbon nanotube assembly 17 is inserted. Further, it is obvious that, in the carbon nanotube fiber 11, the electrical conductivity, tensile strength, and rigidity tend to be higher as the cross-sectional filling rate increases.

Furthermore, the carbon nanotube fibers 11 of Examples 1, 5, and 6 having a cross-sectional filling rate ranging from 58.3 to 73.5% have higher electrical conductivity, tensile strength, and rigidity as compared with the carbon nanotube fibers 11 of Examples 2, 3, 4, 7, and 8 having a cross-sectional filling rate ranging from 9.0 to 39.1%, and it is obvious that the former has excellent electrical conductivity and mechanical property.

### EXAMPLE 10

In this Example, a carbon nanotube assembly 17 was first formed in exactly the same manner as in Example 1.

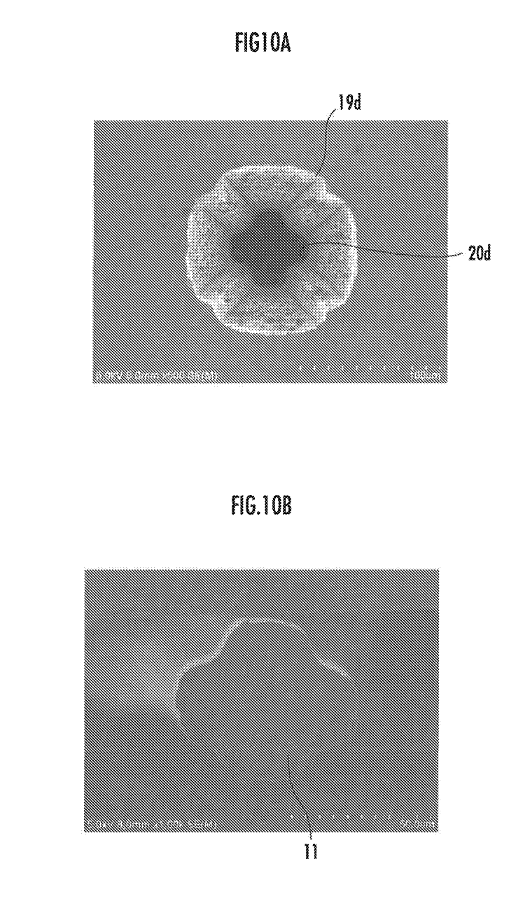

Next, a carbon nanotube fiber 11 was formed in exactly the same manner as in Example 1 except that the resulting carbon nanotube assembly 17 was used, and a die 19d having a cross-shaped pore 20d was used instead of a die 19d having a generally circular pore 20d. The die 19d having a cross-shaped pore 20d was formed by forming a cross-shaped mask on a Si substrate having a thickness of 100 μm and forming the pore 20d by a photolithography technique. FIG. 10A shows an enlarged picture when the die 19d was observed by SEM.

Next, the cross section of the resulting carbon nanotube fiber 11 was observed by SEM. FIG. 10B shows an enlarged cross-sectional picture of the carbon nanotube fiber 11. FIG. 10B reveals that the resulting carbon nanotube fiber 11 comprises a cross-shaped cross section corresponding to the cross-shaped cross section of the pore 20d of the die 19d arranged on the most downstream side in the spinning direction.

### EXAMPLE 11

In this Example, a carbon nanotube assembly 17 was first formed in exactly the same manner as in Example 1.

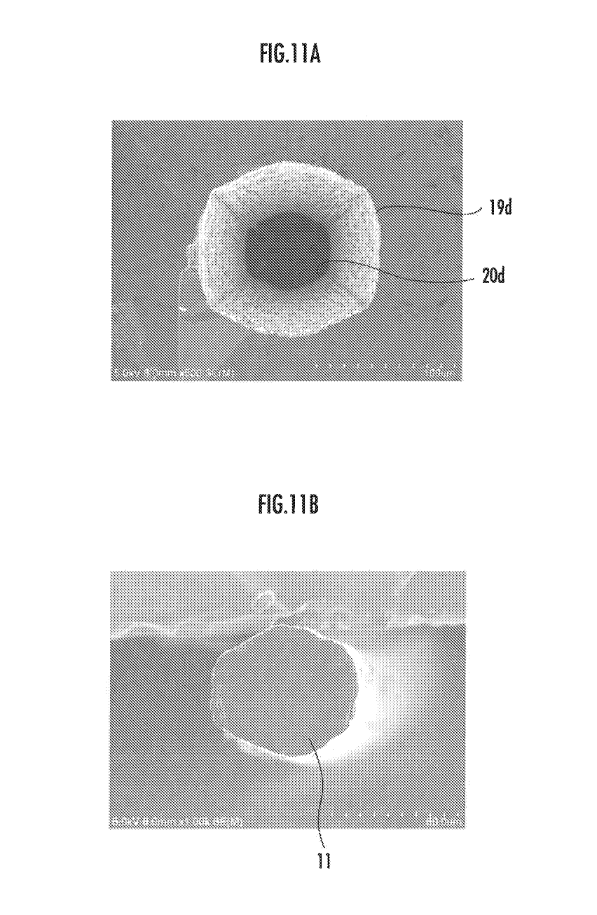

Next, a carbon nanotube fiber 11 was formed in exactly the same manner as in Example 1 except that the resulting carbon nanotube assembly 17 was used, and a die 19d having a generally hexagonal pore 20d was used instead of a die 19d having a generally circular pore 20d. The die 19d having a generally hexagonal pore 20d was formed by forming a hexagonal mask on a Si substrate and forming the pore 20d by a photolithography technique. FIG. 11A shows an enlarged picture when the die 19d was observed by SEM.

Next, the cross section of the resulting carbon nanotube fiber 11 was observed by SEM. FIG. 11B shows an enlarged cross-sectional picture of the carbon nanotube fiber 11. FIG. 11B reveals that the resulting carbon nanotube fiber 11 comprises a generally hexagonal cross section corresponding to the generally hexagonal cross section of the pore 20d of the die 19d arranged on the most downstream side in the spinning direction.

Therefore, Examples 10 and 11 reveal that carbon nanotubes 11 each comprising a desired cross-sectional shape corresponding to the cross-sectional shape of the pore 20 can be obtained by controlling the cross-sectional shape of the 20d of the die 19d arranged on the most downstream side in the spinning direction.

### EXAMPLE 12

In this Example, a carbon nanotube fiber 11 was produced using the spinning apparatus 15 shown in FIG. 3A instead of the spinning apparatus 15 shown in FIG. 1.

A carbon nanotube assembly 17 was first formed in exactly the same manner as in Example 1.

Next, a carbon nanotube fiber 11 was formed in exactly the same manner as in Example 1 except that the resulting carbon nanotube assembly 17 was used, and the spinning apparatus 15 shown in FIG. 3A was used instead of the spinning apparatus 15 shown in FIG. 1.

In the spinning apparatus 15 shown in FIG. 3A, a thread member 22 consisting of a TiNi shape memory alloy wire of a diameter of 40 μm wound around the roller 21 was continuously inserted into the central part of each pore 20 of each die 19, and by actuating the drawing unit 16 without rotating the roller 21, only the carbon nanotubes 12 were wound by the drawing unit 16 while leaving the thread member 22.

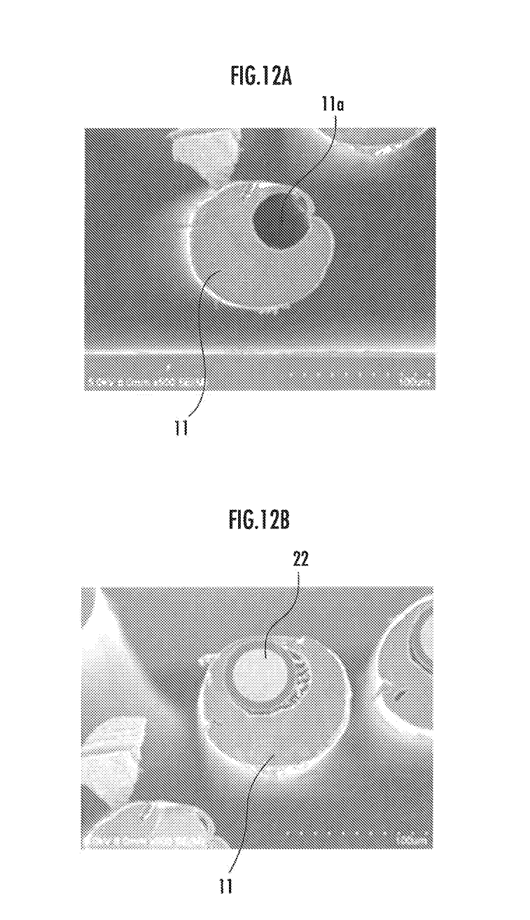

Next, the cross section of the resulting carbon nanotube fiber 11 was observed by SEM. FIG. 12A shows an enlarged cross-sectional picture of the carbon nanotube fiber 11.

FIG. 12A reveals that the resulting carbon nanotube fiber 11 comprises a pore 11a in the approximately central part corresponding to the cross-sectional shape of the thread member 22.

### EXAMPLE 13

In this Example, a carbon nanotube fiber 11 was produced using the spinning apparatus 15 shown in FIG. 3B instead of the spinning apparatus 15 shown in FIG. 1.

In this Example, a carbon nanotube assembly 17 was first formed in exactly the same manner as in Example 1.

Next, a carbon nanotube fiber 11 was formed in exactly the same manner as in Example 1 except that the resulting carbon nanotube assembly 17 was used, and the spinning apparatus 15 shown in FIG. 3A was used instead of the spinning apparatus 15 shown in FIG. 1.

In the spinning apparatus 15 shown in FIG. 3B, a long threaded member 22 consisting of a copper wire with an insulation coated surface of a diameter of 40 μm wound around the roller 21 was continuously inserted into the central part of each pore 20 of each die 19, and by actuating the drawing unit 16 while rotating the roller 21, the carbon nanotubes 12 were wound by the drawing unit 16 along with the thread member 22.

Next, the cross section of the resulting carbon nanotube fiber 11 was observed by SEM. FIG. 12B shows an enlarged cross-sectional picture of the carbon nanotube fiber 11.

FIG. 12B reveals that the resulting carbon nanotube fiber 11 comprises the thread member 22 inserted into the approximately central part thereof. It is expected that the carbon nanotube 11 of this Example comprises a function resulting from the copper wire constituting the thread member 22.

What is claimed is:

1. A carbon nanotube fiber of a long-length in which a plurality of carbon nanotubes are assembled,
wherein the carbon nanotubes comprise a diameter ranging from 0.4 to 100 nm and are oriented in an angle ranging from 0 to 5° with respect to an axial direction of the carbon nanotube fiber.

2. The carbon nanotube fiber according to claim 1,
wherein the carbon nanotubes comprise a length ranging from 10 to 5000 μm.

3. The carbon nanotube fiber according to claim 1,
wherein a cross-sectional filling rate as a proportion of the carbon nanotubes with respect to the cross-sectional area of the carbon nanotube fiber ranges from 50 to 95%.

4. The carbon nanotube fiber according to claim 1,
wherein the carbon nanotube fiber comprises a desired cross-sectional shape.

5. The carbon nanotube fiber according to claim 4,
wherein the desired cross-sectional shape is a shape selected from the group consisting of a circle, an ellipse, a convex polygon, and a concave polygon.

6. The carbon nanotube fiber according to claim 5,
wherein the desired cross-sectional shape is a hexagon or a cruciform.

7. The carbon nanotube fiber according to claim 1,
wherein the carbon nanotube fiber comprises a pore portion in a central part of the carbon nanotube fiber.

8. The carbon nanotube fiber according to claim 1,
wherein a thread member is inserted into a central part of the carbon nanotube fiber.

9. The carbon nanotube fiber according to claim 8,
wherein the thread member is a wire consisting of at least one type of material selected from the group consisting of a metal, a metal oxide, a glass fiber, a carbide, a carbon fiber, and a resin.

10. The carbon nanotube fiber according to claim 9,
wherein the thread member consists of a copper or TiNi.

11. A method for producing a carbon nanotube fiber of a long-length in which a plurality of carbon nanotubes are assembled, comprising the steps of:
paralleling a plurality of carbon nanotubes comprising a diameter ranging from 0.4 to 100 nm from a carbon nanotube forest in which the plurality of the carbon nanotubes are grown on a substrate, and forming a carbon nanotube assembly of a bundled shape; and
inserting the carbon nanotube assembly into a pore having a diameter smaller than the diameter of the carbon nanotube assembly, and forming the carbon nanotube fiber by orienting and assembling the plurality of the carbon nanotubes in an angle ranging from 0 to 5° with respect to an axial direction.

12. The method for producing the carbon nanotube fiber according to claim 11,
wherein the carbon nanotubes comprises a length ranging from 10 to 5000 μm.

13. The method for producing the carbon nanotube fiber according to claim 11,
wherein the substrate is a Si substrate on which an Al film and an Fe film are deposited.

14. The method for producing the carbon nanotube fiber according to claim 11,
wherein the carbon nanotube forest has a density of 5 to 388 mg/cm³.

15. The method for producing the carbon nanotube fiber according to claim 11, further comprising the step of:
removing impurities from the carbon nanotube assembly, between the step of forming the carbon nanotube assembly and the step of inserting the carbon nanotube assembly into the pore.

16. The method for producing the carbon nanotube fiber according to claim 15,
wherein the step of removing impurities is performed by blowing the impurities with a blower.

17. The method for producing the carbon nanotube fiber according to claim 11,
wherein the carbon nanotube assembly is inserted into a plurality of pores in which the diameter of the pores decreases in steps from an upstream side toward a downstream side in a spinning direction.

18. The method for producing the carbon nanotube fiber according to claim 11,
wherein the cross section of the pore arranged on a most downstream side in a spinning direction comprises a shape corresponding to a desired cross-sectional shape of the carbon nanotube fiber.

19. The method for producing the carbon nanotube fiber according to claim 18,
wherein the desired cross-sectional shape is a shape selected from the group consisting of a circle, an ellipse, a convex polygon, and a concave polygon.

20. The method for producing the carbon nanotube fiber according to claim 19,
wherein the desired cross-sectional shape is a shape selected from the group consisting of a hexagon and a cruciform.

21. The method for producing the carbon nanotube fiber according to claim 11,
wherein the pore comprises a core arranged in the central part thereof.

22. The method for producing the carbon nanotube fiber according to claim 21,
wherein the core is a thread member.

23. The method for producing the carbon nanotube fiber according to claim 22,
wherein the thread member is a wire consisting of at least one type of material selected from the group consisting of a metal, a metal oxide, a glass fiber, a carbide, a carbon fiber, and a resin.

24. The method for producing the carbon nanotube fiber according to claim 23,
wherein the thread member consists of a copper or a TiNi.

25. The method for producing the carbon nanotube fiber according to claim 11, further comprising the step of:
winding up the carbon nanotube fiber in which a thread member is arranged in the central part thereof by a drawing unit,
wherein the drawing unit is configured to draw the plurality of the carbon nanotubes from the carbon nanotube forest and wind up the carbon nanotube fiber in which the plurality of the carbon nanotubes are assembled and
the thread member of a long-length is arranged in the central part of the pore along the longitudinal direction thereof.

26. The method for manufacturing the carbon nanotube fiber according to claim 25,
wherein the thread member is a wire consisting of at least one type of material selected from the group consisting of a metal, a metal oxide, a glass fiber, a carbide, a carbon fiber, and a resin.

27. The method for manufacturing the carbon nanotube fiber according to claim 26,
wherein the thread member comprises a copper or a TiNi.
